(19) United States
(12) Patent Application Publication
(10) Pub. No.: US 2005/0133731 A1
(43) Pub. Date: Jun. 23, 2005

(54) Radiation image storage panel

(75) Inventors: Hiroshi Matsumoto, Kanagawa (JP); Yuichi Hosoi, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/017,960

(22) Filed: Dec. 22, 2004

(30) Foreign Application Priority Data
Dec. 22, 2003 (JP) 2003-425513

(51) Int. Cl. G21K 4/00

(52) U.S. Cl. 250/484.4

(57) ABSTRACT

A radiation image storage panel is composed of a support and a phosphor layer formed on one surface of the support by gas phase-accumulation, in which the support shows a contact angle of 50° or less with respect to water on the surface on which the phosphor layer is formed.

### FIELD OF THE INVENTION

The present invention relates to a radiation image storage panel employable in a radiation image recording and reproducing method utilizing an energy-storable phosphor.

### BACKGROUND OF THE INVENTION

When an energy-storable phosphor (e.g., stimulable phosphor, which gives off stimulated emission) is exposed to radiation such as X-rays, it absorbs and stores a portion of energy of the radiation. The phosphor then produces stimulated emission according to the level of the stored energy when exposed to electromagnetic wave such as visible or infrared light (i.e., stimulating light). A radiation image recording and reproducing method utilizing the energy-storable phosphor has been widely employed in practice. In that method, a radiation image storage panel, which is a sheet comprising the energy-storable phosphor, is used. The method comprises the steps of: exposing the storage panel to radiation having passed through an object or having radiated from an object, so that radiation image of the object is temporarily recorded in the storage panel; sequentially scanning the storage panel with a stimulating light such as a laser beam to emit a stimulated light; and photoelectrically detecting the emitted light to obtain electric image signals. The storage panel thus processed is then subjected to a step for erasing radiation energy remaining therein, and then stored for the use in the next recording and reproducing procedure. Thus, the radiation image storage panel can be repeatedly used.

The radiation image storage panel (often referred to as energy-storable phosphor sheet) has a basic structure comprising a support and a phosphor layer provided thereon. Further, a protective layer is generally provided on the free surface (surface not facing the support) of the phosphor layer to keep the phosphor layer from chemical deterioration or physical damage.

Various kinds of phosphor layers are known. For example, a phosphor layer comprising a binder and an energy-storable phosphor dispersed therein is generally used, and a phosphor layer comprising agglomerate of an energy-storable phosphor without binder is known. The latter layer can be formed by a gas phase-accumulation method or by a firing method.

The radiation image recording and reproducing method (or radiation image forming method) has various advantages as described above. It is still desired that the radiation image storage panel used in the method have as high sensitivity as possible and, at the same time, give a reproduced radiation image of high quality (in regard to sharpness and graininess).

In order to improve the sensitivity and the image quality, it has been proposed that the phosphor layer of the radiation image storage panel be prepared by a gas phase-accumulation method such as vacuum vapor deposition, sputtering or chemical vapor deposition (CVD). The process of vacuum vapor deposition, for example, comprises the steps of: heating to vaporize an evaporation source comprising a phosphor or its starting materials by means of a resistance heater or an electron beam, and depositing and accumulating the vapor on a substrate such as a metal sheet to form a layer of the phosphor in the form of columnar crystals.

The phosphor layer formed by the gas phase-accumulation method contains no binder and consists essentially of phosphor, and there are gaps among the columnar crystals of the phosphor. Due to the presence of gaps in the phosphor layer, the stimulating light can stimulate the phosphor efficiently and the emitted light can be collected efficiently. Accordingly, a radiation image storage panel having such phosphor layer shows high sensitivity. Further, since the gaps in the phosphor layer prevent the stimulating light from diffusing parallel to the phosphor layer, the radiation image storage panel can give a reproduced radiation image of high sharpness.

Japanese Patent Provisional Publication 4-118599 describes an X-ray image conversion sheet comprising a stimulable phosphor layer and an aluminum substrate in which a white oxide layer is placed between the aluminum substrate and the phosphor layer. The Publication further described an X-ray image conversion sheet comprising an anodic-oxidized black aluminum substrate and a stimulable phosphor layer.

Japanese Patent No. 3,034,587 describes a radiation image conversion panel comprising a substrate having a metal surface, a stimulable phosphor layer, and a protective layer in which a transparent film is placed on the substrate. The transparent film comprises oxide such as SiO₂, Al₂O₃, or TiO₂.

A phosphor layer formed on a metal substrate (support) by vapor deposition generally shows poor fixation onto the substrate. Therefore, when the resulting radiation storage panel is repeatedly employed in the radiation image recording and reproducing procedure, the phosphor layer is apt to easily peel off from the substrate. The provision of an oxide layer onto the metal substrate does not satisfactorily improve the poor fixation of the phosphor layer onto the substrate.

### SUMMARY OF THE INVENTION

Accordingly, the present invention has an object to provide a radiation image storage panel in which a phosphor layer is fixed onto a surface of the support (i.e., substrate) with a high bonding force.

The present inventors studied the fixation of a phosphor layer onto a substrate and noted that there is a close relationship between the adhesion and a surface energy of the substrate. In more detail, a substrate having a high surface energy provides improved fixation of a phosphor layer onto the substrate.

The present invention resides in a radiation image storage panel comprising a support and a phosphor layer formed on one surface of the support by gas phase-accumulation, in which the support shows a contact angle of 50° or less with respect to water on the surface on which the phosphor layer is formed.

In the radiation image storage panel of the invention, it is preferred that the contact angle is 20° or less. Preferred examples of the supports are an aluminum sheet or a glass sheet which has been defatted or subjected to hydrophilic treatment or plasma processing. Otherwise, the surface of the support on which the phosphor layer is formed may have a hydrophilic layer comprising an oxide.

The invention also resides in a process for preparing the radiation image storage panel of the invention, which comprises the steps of:
preparing a support showing a contact angle of 50° or less with respect to water on one surface thereof, and
depositing a phosphor layer on the surface of the support by gas phase accumulation.

### BRIEF DESCRIPTION OF DRAWINGS

FIG. 1 shows a constitution of a radiation image storage panel according to the invention.

FIG. 2 shows a concept of a contact angle (θ) of a support surface with respect to water.

### DETAILED DESCRIPTION OF THE INVENTION

In the radiation image storage panel of the invention, the phosphor layer preferably comprises columnar crystals of an energy-storable phosphor. The relative density of the phosphore layer preferably is in the range of 60% to 90%.

The energy-storable phosphor preferably is a stimulable alkali metal halide phosphor represented by the formula (I):
M^{I}X.aM^{II}X′₂.bM^{III}X″₃:zA (I)
in which M^{I} is at least one alkali metal selected from the group consisting of Li, Na, K, Rb and Cs; M^{II} is at least one alkaline earth metal or divalent metal selected from the group consisting of Be, Mg, Ca, Sr, Ba, Ni, Cu, Zn and Cd; M^{III} is at least one rare earth element or trivalent metal selected from the group consisting of Sc, Y, La, Ce, Pr, Nd, Pm, Sm, Eu, Gd, Th, Dy, Ho, Er, Tm, Yb, Lu, Al, Ga and In; each of X, X′ and X″ is independently at least one halogen selected from the group consisting of F, Cl, Br and I; A is at least one rare earth element or metal selected from the group consisting of Y, Ce, Pr, Nd, Sm, Eu, Gd, Tb, Dy, Ho, Er, Tm, Yb, Lu, Mg, Cu and Bi; and a, b and z are numbers satisfying the conditions of 0≦a<0.5, 0≦b<0.5 and 0<z<1.0, respectively.

In formula (1), M^{I} is Cs, X is Br, A is Eu, and z is a number satisfying the condition of 1×10⁻⁴≦z≦0.1.

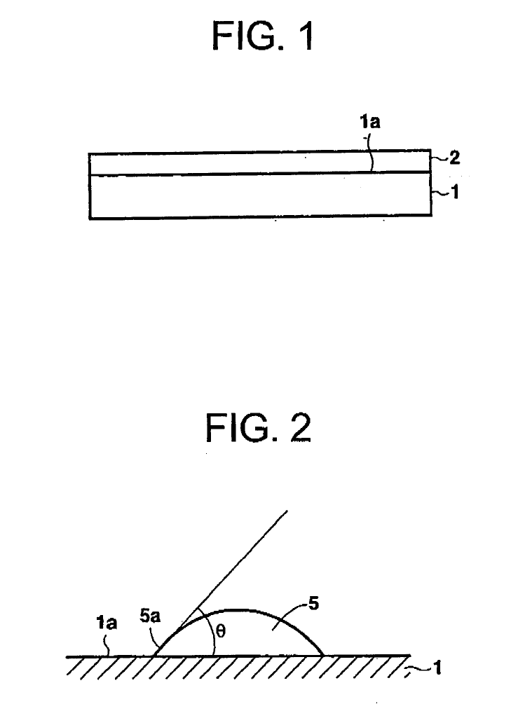

The radiation image storage panel of the invention is further described by referring to FIG. 1 in the attached drawing.

In FIG. 1, the radiation image panel comprises a support 1 and a phosphor layer 2 formed by gas phase accumulation. The surface 1a of the support 1 shows a low contact angle with respect to water. The contact angle (θ) with respect to water is illustrated in FIG. 2 in which the support is indicated by 1, the support surface on which the phosphor layer is formed is indicated by 1a, water is indicated by 5, and a surface of water is indicated by 5a.

In the invention, the support 1 preferably is an aluminum sheet or a glass sheet. The surface 1a of the support on which a phosphor layer is formed may have a thin layer comprising an oxide such as Al₂O₃, SiO₂, or TiO₂. The thin oxide layer can be placed on the support, for instance, by vapor deposition, sputtering, ion-plating, or spread coating. Otherwise, a metal support may be subjected to anode-oxidation. Generally, the anode-oxidized surface has a great number of micro-pores. The micro-pores are preferably not sealed.

The known support such as an aluminum sheet or a glass sheet can be employed in the invention after it is subjected to hydrophilic treatment such as washing with an alkaline solution, plasma processing, or defatting. If the support has a thin oxide layer on its surface, the oxide layer is hydrophilically processed on its surface. The defatting can be performed by known procedures such as those using an organic solvent (e.g., acetone), a surface active agent, an acid, or an alkaline solution.

The aluminum sheet or glass sheet can be replaced with a known support material such as a quartz sheet, sapphire sheet, iron sheet, tin sheet, chromium sheet, or a resin sheet such as an aramide resin sheet. The surface of the support can have small sized convexes or concaves, so as to assist formation of a phosphor layer having well shaped columnar crystals.

Thus treated support surface shows a low contact angle with respect to water (this means that the support surface has a high surface energy), and a vapor-deposited phosphor layer is well fixed onto the treated support.

In the following description, the process-for preparation of the radiation image storage panel of the invention is explained in detail, by way of example, in the case where the phosphor is an energy-storable phosphor and where a vapor deposition process employing a resistance-heater is adopted as the gas phase-accumulation method. Since the vapor deposition utilizing a resistance-heater can be carried out under a medium vacuum condition, it is easy to form a vapor-deposited layers excellent in columnar crystallinity.

The energy-storable phosphor preferably is a stimulable phosphor giving off stimulated emission in the wave-length region of 300 to 500 nm when exposed to a stimulating ray in the wavelength region of 400 to 900 nm.

The phosphor particularly preferably is a stimulable alkali metal halide phosphor represented by the formula (I):
M^{I}X.aM^{II}X′₂.bM^{III}X″₃:zA (I)
in which M^{I} is at least one alkali metal selected from the group consisting of Li, Na, K, Rb and Cs; M^{II} is at least one alkaline earth metal or divalent metal selected from the group consisting of Be, Mg, Ca, Sr, Ba, Ni, Cu, Zn and Cd; M^{III} is at least one rare earth element or trivalent metal selected from the group consisting of Sc, Y, La, Ce, Pr, Nd, Pm, Sm, Eu, Gd, Tb, Dy, Ho, Er, Tm, Yb, Lu, Al, Ga and In; each of X, X′ and X″ is independently at least one halogen selected from the group consisting of F, Cl, Br and I; A is at least one rare earth element or metal selected from the group consisting of Y, Ce, Pr, Nd, Sm, Eu, Gd, Tb, Dy, Ho, Er, Tm, Yb, Lu, Mg, Cu and Bi; and a, b and z are numbers satisfying the conditions of 0≦a<0.5, 0≦b<0.5 and 0<z<1.0, respectively.

In the formula (I), z preferably is a number satisfying the condition of 1×10⁻⁴≦z≦0.1; M^{I} preferably comprises at least Cs; X preferably comprises at least Br; and A is preferably Eu or Bi, more preferably Eu. The phosphor represented by the formula (I) may further comprise metal oxides such as aluminum oxide, silicon dioxide and zirconium oxide as additives in an amount of 0.5 mol or less based on one mol of M^{I}X.

As the phosphor, it is also preferred to use a rare earth activated alkaline earth metal fluoride halide stimulable phosphor represented by the formula (II):
M^{II}FX:zLn (II)
in which M^{II} is at least one alkaline earth metal selected from the group consisting of Ba, Sr and Ca; Ln is at least one rare earth element selected from the group consisting of Ce, Pr, Sm, Eu, Th, Dy, Ho, Nd, Er, Tm and Yb; X is at least one halogen selected from the group consisting of Cl, Br and I; and z is a number satisfying the condition of 0<z≦0.2.

In the formula (II), M^{II} preferably comprises Ba more than half of the total amount of M^{II}, and Ln preferably is Bu or Ce. The M^{II}FX in the formula (II) represents a matrix crystal structure of BaFX type, and it by no means indicates stoichiometrical composition of the phosphor. Accordingly, the molar ratio of F:X is not always 1:1. It is generally preferred that the BaFX type crystal have many F⁺(X⁻) centers corresponding to vacant lattice points of X⁻ ions since they increase the efficiency of stimulated emission in the wavelength region of 600 to 700 nm. In that case, F is often slightly in excess of X.

Although not described in the formula (II), one or more additives such as bA, wN^{I}, xN^{II} and yN^{III} may be incorporated into the phosphor of the formula (II). A is a metal oxide such as Al₂O₃, SiO₂ or ZrO₂. In order to prevent M^{II}FX particles from sintering, the metal oxide preferably has low reactivity with M^{II}FX and the primary particles of the oxide are preferably super-fine particles of 0.1 μm or less diameter. N^{I} is a compound of at least one alkali metal selected from the group consisting of Li, Na, K, Rb and Cs; N^{II} is a compound of alkaline earth metal(s) Mg and/or Be; and N^{III} is a compound of at least one trivalent metal selected from the group consisting of Al, Ga, In, Tl, Sc, Y, La, Gd and Lu. The metal compounds preferably are halides, but are not restricted to them.

In the formulas, b, w, x and y represent amounts of the additives incorporated into the starting materials, provided that the amount of M^{II}FX is assumed to be 1 mol. They are numbers satisfying the conditions of 0≦b≦0.5, 0≦w≦2, 0≦x≦0.3 and 0≦y≦0.3, respectively. These numbers by no means always represent the contents in the resultant phosphor because some of the additives decrease during the steps of firing and washing performed thereafter.

Some additives remain in the resultant phosphor as they are added to the materials, but the others react with M^{II}FX or are involved in the matrix,

In addition, the phosphor of the formula (II) may further comprise Zn and Cd compounds; metal oxides such as TiO₂, BeO, MgO, CaO, SrO, BaO, ZnO, Y₂O₃, La₂O_{3,} In₂O₃, GeO₂, SnO₂, Nb₂O₅, Ta₂O₅ and ThO₂; Zr and Sc compounds; B compounds; As and Si compounds; tetrafluoro-borate compounds; hexafluoro compounds such as monovalent or divalent salts of hexa-fluorosilicic acid, hexafluoro-titanic acid and hexa-fluorozirconic acid; or compounds of transition metals such as V, Cr, Mn, Fe, Co and Ni. The phosphor employable in the invention is not restricted to the above-mentioned phosphors, and any phosphor that can be essentially regarded as rare earth activated alkaline earth metal fluoride halide stimulable phosphor can be used.

Stimulable rare earth-activated alkaline earth metal sulfide phosphors having the following formula (III) are also preferred:
M^{III}OX:Ce (III)

In the formula (III), M^{III} represents at least one rare earth metal or trivalent metal selected from the group consisting of Pr, Nd, Pm, Sm, Eu, Th, Dy, Ho, Er, Tm, Yb and Bi; X is a halogen atom selected from the group consisting of Cl, Br, and I.

The phosphor in the invention is not restricted to the energy-storable phosphor. It may be a phosphor absorbing radiation such as X-rays and then spontaneously giving off (spontaneous) emission in the ultraviolet or visible region. Examples of that phosphor include phosphors of LnTaO₄: (Nb, Gd) type, Ln₂SiO₅:Ce type and LnOX:Tm type (Ln is a rare earth element); CsX (X is a halogen); Gd₂O₂S :Tb; Gd₂O₂S Pr,Ce; ZnWO₄; LuAlO₃; Gd₃Ga₅O₁₂:Cr,Ce; and HfO₂.

For the preparation of the radiation image storage panel of the invention, the phosphor layer is formed by gas phase-accumulation such as vapor deposition.

In the case where a phosphor layer is formed by multi-vapor deposition (co-deposition), at least two evaporation sources are used. One of the sources contains a matrix compound of the energy-storable phosphor, and the other contains an activator compound. The multivapor deposition is preferred because the vaporization rate of each source can be independently controlled to incorporate the activator uniformly in the matrix even if the compounds have very different melting points or vapor pressures. According to the composition of the desired phosphor, each evaporation source may consist of the matrix compound or the activator compound only or otherwise may be a mixture thereof with additives. Three or more sources may be used. For example, in addition to the above-mentioned sources, an evaporation source containing additives may be used.

The matrix compound of the phosphor may be either the matrix compound itself or a mixture of two or more substances that react with each other to produce the matrix compound. The activator compound generally is a compound containing an activating element, and hence is, for example, a halide or oxide of the activating element.

If the activator is Eu, the Eu-containing compound of the activator compound preferably contains Eu²⁺ as much as possible because the desired stimulated emission (even if, spontaneous emission) is emitted from the phosphor activated by EU²⁺. Since commercially available Eu-containing compounds generally contain oxygen atoms, they necessarily contain both Eu²⁺ and Eu³⁺. The Eu-containing compounds, therefore, are preferably melted under Br gas-atmosphere so that oxygen-free EuBr₂ can be prepared.

The evaporation source may have a water content of not more than 0.5 wt. %. For preventing the source from bumping, it is particularly important to control the water content in the above low range if the compound of matrix or activator is a hygroscopic substance such as EuBr or CsBr. The compounds are preferably dried by heating at 100 to 300° C. under reduced pressure. Otherwise, the compounds may be heated under dry atmosphere such as nitrogen gas atmosphere to melt at a temperature above the melting point for several minutes to several hours.

The evaporation source, particularly the source containing the matrix compound, may contain impurities of alkali metal (alkali metals other than ones constituting the phosphor) in a content of 10 ppm or less and impurities of alkaline earth metal (alkaline earth metals other than ones constituting the phosphor) preferably in a content of 5 ppm or less (by weight). That is particularly preferred if the phosphor is an alkali metal halide stimulable phosphor represented by the aforementioned formula (I). Such preferred evaporation source can be prepared from compounds containing little impurities.

The two or more evaporation sources and the substrate are placed in a vacuum evaporation-deposition apparatus. The apparatus is then evacuated to give a medium vacuum of 0.1 to 10 Pa, preferably 0.1 to 4 Pa. It is particularly preferred that, after the apparatus is evacuated to a high vacuum of 1×10⁻⁵ to 1×10² Pa, an inert gas such as Ar, Ne or N₂ gas be introduced into the apparatus so that the inner pressure can be the above-mentioned medium vacuum. In this case, partial pressures of water and oxygen can be reduced. The apparatus can be evacuated by means of an optional combination of, for example, a rotary pump, a turbo molecular pump, a cryo pump, a diffusion pump and a mechanical booster.

For heating the evaporation sources, electric currents are then supplied to resistance heaters. The sources of matrix and activator compounds are thus heated, vaporized, and reacted with each other to form the phosphor, which is deposited and accumulated on the underlayer. The space between the substrate and each source varies depending upon various conditions such as the size of substrate, but generally is in the range of 10 to 1,000 mm, preferably in the range of 10 to 200 mm. The space between the adjoining sources generally is in the range of 10 to 1,000 mm. In this step, the substrate can be heated or cooled. The temperature of the substrate generally is kept in the range of 20 to 350° C., preferably in the range of 100 to 300° C. The deposition rate, which means how fast the formed phosphor is deposited and accumulated on the substrate, can be controlled by adjusting the electric currents supplied to the heaters. The deposition rate generally is in the range of 0.1 to 1,000 μn/min, preferably in the range of 1 to 100 μn/min.

In advance of a deposition of the phosphor layer, a underlayer comprising mainly the matrix compound can be formed on the support. The underlayer and the phosphor layer can be deposited successively on the support. This can be carried out by first heating and evaporating an evaporation source of an matrix compound only, to deposit the matrix compound on the support to form the underlayer, and then heating and evaporating the evaporation source of matrix compound and the evaporation source of an activator compound simultaneously, to deposit the desired phosphor on the underlayer. If desired, the support can be heated when the depositions are carried out. The support is preferably kept at a temperature of 20 to 350° C.

After the deposition procedure is complete, the deposited layer is preferably subjected to heat treatment (annealing), which is carried out generally at a temperature of 100 to 300° C. for 0.5 to 3 hours, preferably at a temperature of 150 to 250° C. for 0.5 to 2 hours, under inert gas atmosphere which may contain a small amount of oxygen gas or hydrogen gas.

Thus formed deposited layers are composed of the underlayer comprising a matrix compound of the phosphor and the phosphor layer comprising an energy-storable phosphor in the form of columnar structure grown almost in the thickness direction. The phosphor layer generally has a thickness of 50 μm to 1 mm, preferably 200 μm to 700 μm.

The gas phase-accumulation method employable in the invention is not restricted to the above-described resistance heating procedure, and various other known processes such as a sputtering process and a CVD process can be used.

It is preferred to provide a protective layer on the surface of the phosphor layer, so as to ensure good handling of the storage panel in transportation and to avoid damage. The protective layer is preferably transparent so as not to prevent the stimulating light from coming in or not to prevent the emission from coming out. Further, for protecting the storage panel from chemical deterioration and physical damage, the protective layer preferably is chemically stable, physically strong, and of high moisture proof.

The protective layer can be provided by coating the phosphor layer with a solution in which an organic polymer such as cellulose derivatives, polymethyl methacrylate or fluororesins is dissolved in an organic solvent, by placing a beforehand prepared sheet for the protective layer (e.g., a film of organic polymer such as polyethylene terephthalate, a transparent glass plate) on the phosphor layer with an adhesive, or by depositing vapor of inorganic compounds on the phosphor layer. Various additives may be dispersed in the protective layer. Examples of the additives include light-scattering fine particles (e.g., particles of magnesium oxide, zinc oxide, titanium dioxide and alumina), a slipping agent (e.g., powders of perfluoroolefin resin and silicone resin) and a crosslinking agent (e.g., polyisocyanate). The thickness of the protective layer generally is in the range of about 0.1 to 20 μm if the layer is made of polymer material, or in the range of about 100 to 1,000 μm if the layer is made of inorganic material such as glass.

For enhancing resistance to stain, a fluororesin layer may be further provided on the protective layer. The fluororesin layer can be form by coating the surface of the protective layer with a solution in which a fluororesin is dissolved (or dispersed) in an organic solvent, and drying the coated solution. The fluororesin may be used singly, but a mixture of the fluororesin and a film-forming resin is generally employed. In the mixture, an oligomer having polysiloxane structure or perfluoroalkyl group can be further added. In the fluororesin layer, fine particle filler may be incorporated to reduce blotches caused by interference and to improve the quality of the resultant image. The thickness of the fluororesin layer generally is in the range of 0.5 to 20 μm. For forming the fluororesin layer, additives such as a crosslinking agent, a film-hardening agent and an anti-yellowing agent can be used. In particular, the cross-linking agent is advantageously employed to improve durability of the fluororesin layer.

Thus, a radiation image storage panel of the invention can be produced. The radiation image storage panel of the invention can be in known various structures. For example, in order to improve the sharpness of the resultant image, at least one layer may be colored with a colorant which does not absorb the stimulated emission but the stimulating light.

### EXAMPLE 1

(1) Evaporation Source

As the evaporation sources, powdery cesium bromide (CsBrₘ, m is nearly 2.2, purity; more than 4N) and powdery europium bromide (EuBr₂, purity: more than 3N) were prepared. Each was analyzed according to ICP-MS method (Inductively Coupled Plasma Mass Spectrometry), to examine contents of impurities. As a result, the CsBr powder contained each of the alkali metals (Li, Na, K, Rb) other than Cs in an amount of 10 ppm or less and other elements such as alkaline earth metals (Mg, Ca, Sr, Ba) in amounts of 2 ppm or less. The EuBra powder contained each of the rare earth elements other than Eu in an amount of 20 ppm or less and other elements in amounts of 10 ppm or less. The powders are very hygroscopic, and hence were stored in a desiccator keeping a dry condition whose dew point was lower than −20° C. They were taken out of the desiccator, immediately before they were used.

(2) Preparation of Support

Aluminum substrates (supports, thickness: 1 mm) were defatted by washing successively with an aqueous weak alkaline solution (TOP ALCLEAN 161, available from Okuno Pharmaceutical Co., Ltd.) and purified water. Thus washed substrate was dried and kept in a sealed vessel under such condition that each substrate was placed independently and kept from foreign materials.

(3) Deposition of Phosphor Layer

The washed and dried substrate was taken out of the vessel at a lapse of approx. 50 days after it was placed in the vessel. The substrate was then mounted to a substrate holder in an evaporation-deposition apparatus. Each of the CsBr and EuBrₘ evaporation sources were individually placed in crucibles equipped with resistance heaters, respectively. The evaporation sources were placed at spaces of 15 cm from the substrate. The apparatus was then evacuated to make the inner pressure 1×10⁻³ Pa by opening a main exhaust valve and using a combination of a rotary pump, a mechanical booster and a diffusion pump. Further, a cryo pump was employed for removing water vapor from the apparatus. Subsequently, the main valve was closed and a bypass valve was opened to introduce Ar gas to set the inner pressure at 5×10⁻² Pa. Thereafter, a plasma generation apparatus (i.e., ion gun) was activated to generate plasma to wash the surface of the substrate. Then, the bypass valve was closed and the main valve was again opened to set the inner pressure to 1×10⁻³ Pa. The main valve was again closed, and the by-pass valve was again opened, to set the inner pressure to 0.2 Pa (Ar gas pressure). The substrate was then heated to 100° C. by means of a sheath heater placed on the back side (side opposite to the surface on which the vapor was to be deposited). While a shutter placed between the substrate and each source was closed, each evaporation source was heated by means of the resistance heater. The shutter covering the CsBr source was first opened so that CsBr alone was accumulated on the substrate to form an underlayer of CsBr matrix compound. At a lapse of 3 min. after the underlayer was formed on the substrate, the shutter covering the EuBr₂ source was then opened so that stimulable CsBr:Eu phosphor was accumulated on the underlayer at the rate of 8 μm/min., to form a phosphor layer comprising the phosphor in the form of columnar crystal-line structure grown almost perpendicularly and aligned densely (thickness: 500 μm, area: 10 cm×10 cm). During the deposition, the electric currents supplied to the heaters were controlled so that the molar ratio of Eu/Cs in the phosphor would be 0.003/1. After the evaporation-deposition was complete, the inner pressure was returned to atmospheric pressure and then the substrate was taken out of the apparatus.

Thus, a radiation image storage panel of the invention comprising the support and phosphor layer was produced by co-deposition.

### EXAMPLE 2

The procedures of Example 1 were repeated except that the Ar gas pressure introduced into the evaporation-deposition apparatus in the procedure (3) was changed to 1.0 Pa, by varying the amount of Ar gas introduced into the apparatus, to give a radiation image storage panel of the invention.

### EXAMPLE 3

The procedures of Example 1 were repeated except that the aluminum substrate was treated by chemical coating method (boehemite formation) in the procedure (2) to produce an aluminum oxide coat (thickness: 1 μm) on the substrate and that the Ar gas pressure introduced into the evaporation-deposition apparatus in the procedure (3) was changed to 1.0 Pa, to give a radiation image storage panel of the invention.

### EXAMPLE 4

The procedures of Example 1 were repeated except that the aluminum substrate was treated by anodic oxidation (sulfuric acid method, no sealing was made) in the rocedure (2) to produce an aluminum oxide coat (thickness; 5 μm) on the substrate and that the Ar gas pressure introduced into the evaporation-deposition apparatus in the procedure (3) was changed to 1.0 Pa, to give a radiation image storage panel of the invention.

### EXAMPLE 5

The procedures of Example 1 were repeated except that the aluminum substrate was replaced with a glass substrate (thickness: 1 mm) in the procedure (2) and that the Ar gas pressure introduced into the evaporation-deposition apparatus in the procedure (3) was changed to 1.0 Pa, to give a radiation image storage panel of the invention.

### EXAMPLE 6

The procedures of Example 1 were repeated except that the aluminum substrate was replaced with a glass substrate (thickness: 1 mm) in the procedure (2), that the Ar gas pressure introduced into the evaporation-deposition apparatus in the procedure (3) was changed to 1.0 Pa, and that no plasma treating of the glass substrate was performed, to give a radiation image storage panel of the invention.

### COMPARISON EXAMPLE 1

The procedures of Example 1 were repeated except that no plasma treating of the substrate was performed in the procedure (3), to give a radiation image storage panel for comparison.

### COMPARISON EXAMPLE 2

The procedures of Example 1 were repeated except that the Ar gas pressure introduced into the evaporation-deposition apparatus in the procedure (3) was changed to 1.0 Pa and that no plasma treating of the substrate was performed, to give a radiation image storage panel for comparison.

### COMPARISON EXAMPLE 3

The procedures of Example 1 were repeated except that the aluminum substrate was treated by chemical coating method (boehemite formation) in the procedure (2) to produce an aluminum oxide coat (thickness: 1 μm) on the substrate, that the Ar gas pressure introduced into the evaporation-deposition apparatus in the procedure (3) was changed to 1.0 Pa, and that no plasma treating of the aluminum substrate was performed, to give a radiation image storage panel for comparison.

[Evaluation of Radiation Image Storage Panel]

The adhesion (strength of fixation) of the vapor-deposited phosphor layer on the substrate of the radiation storage panel was evaluated in the following manners.

A straight notch (or cut, approx. 3 cm long) was formed on the phosphor layer of the storage panel by a cutter (knife) under such condition that the notch reached on the surface of the substrate. Each of adhesive tapes having different adhesive power (adhesive cellophane tape and gummed cloth tape, width 2 cm, length 5 cm) was placed on the surface of the phosphor layer under such condition that the adhesive tape was brought into contact with the notch on-its one end and arranged perpendicularly to the notch. The 3 cm portion from the one end in contact with the notch was fixed onto the phosphor layer by pressing the portion by a finger. The tape was then pulled quickly in the direction opposite to the notch taking the remaining 2 cm portion. Then, the separation of the phosphor layer from the substrate was visually observed, and marked based on the following criteria:
AA: No separation of the phosphor layer was observed, and the fixation is very satisfactory.
A: Separation was observed when the gummed cloth tape was employed, but the fixation is practically satisfactory.
B: Separation was observed in the use of either the gummed cloth tape or cellophane adhesive tape, and hence the fixation is not enough from the viewpoint of the practical use.
C: Separation was observed even before the storage panel was subjected to the fixation test, and hence the storage panel is not employable from the viewpoint of the practical use.

The results are shown in Table 1. In Table 1, the contact angle (θ) of the substrate with respect to water and a relative density of the phosphor layer are also shown.

TABLE 1

| | | | Ar gas | Relative | |
|---|---|---|---|---|---|
| Example | Substrate | Contact angle(θ) | pressure | density | Fixation |
| Example 1 | aluminum | 12° | 0.2 Pa | 92% | A |
| Example 2 | aluminum | 12° | 1.0 Pa | 80% | AA |
| Example 3 | aluminum | 25° | 1.0 Pa | 82% | AA |
| Example 4 | aluminum | 17° | 1.0 Pa | 80% | AA |
| Example 5 | glass | 5° | 1.0 Pa | 81% | AA |
| Example 6 | glass | 45° | 1.0 Pa | 92% | AA |
| Com. Ex. 1 | aluminum | 110° | 0.2 Pa | 91% | C |
| Com. Ex. 2 | aluminum | 110° | 1.0 Pa | 81% | C |
| Com. Ex. 3 | aluminum | 90° | 1.0 Pa | 81% | C |

Remarks: Surface treating of substrate
Example 1: Alkali washing + atmospheric drying + plasma
washing
Example 2: Alkali washing + atmospheric drying + plasma
washing
Example 3: Alkali washing + oxide coat + plasma
washing
Example 4: Alkali washing + anode oxidation coat + plasma
washing
Example 5: Alkali washing + atmospheric drying + plasma
washing
Example 6: Alkali washing + plasma washing
Com. Ex. 1: Alkali washing + atmospheric drying
Com. Ex. 2: Alkali washing + atmospheric drying
Com. Ex. 3: Alkali washing + oxide coat

The results of Table 1 teach that the phosphor layer of the radiation image storage panels of the invention (Examples 1-6) in which a substrate shows a contact angle (θ) of 50° or less with respect to water was well fixed onto the substrate. Particularly, the phosphor layer deposited on a substrate showing a contact angle of 20° or less (Examples 2, 4 and 7) shows highly improved fixation to the substrate. In contrast, the phosphor layer of the radiation image storage panels for comparison (Comparison Examples 1-3) deposited on a substrate showing a contact angle of higher than 50° is not well fixed to the substrate. It is further noted that the fixation of the phosphor layer to the substrate is further improved when the relative density of the phosphor layer is adjusted to a level within 60 to 90%.

1. A radiation image storage panel comprising a support and a phosphor layer formed on one surface of the support by gas phase-accumulation, in which the support shows a contact angle of 50° or less with respect to water on the surface on which the phosphor layer is formed.

2. The radiation image storage panel of claim 1, wherein the contact angle is 20° or less.

3. The radiation image storage panel of claim 1, wherein the support is an aluminum sheet or a glass sheet which has been subjected to hydrophilic treatment.

4. The radiation image storage panel of claim 1, wherein the surface of the support on which the phosphor layer is formed has been defatted.

5. The radiation image storage panel of claim 1, wherein the surface of the support on which the phosphor layer is formed has been subjected to plasma processing.

6. The radiation image storage panel of claim 1, wherein the surface of the support on which the phosphor layer is formed has a hydrophilic layer comprising an oxide.

7. The radiation image storage panel of claim 1, herein the phosphor layer comprises columnar crystals and has a relative density in the range of 60 to 90%.

8. The radiation image storage panel of claim 1, wherein the phosphor is an energy-storable phosphor.

9. The radiation image storage panel of claim 8, wherein the energy-storable phosphor is a stimulable alkali metal halide phosphor represented by the formula (I):
M^{I}X.aM^{II}X′₂.bM^{III}X″₃: zA (I)
in which M^{I} is at least one alkali metal selected from the group consisting of Li, Na, K, Rb and Cs; M^{II} is at least one alkaline earth metal or divalent metal selected from the group consisting of Be, Mg, Ca, Sr, Ba, Ni, Cu, Zn and Cd; M^{III} is at least one rare earth element or trivalent metal selected from the group consisting of Sc, Y, La, Ce, Pr, Nd, Pm, Sm, Eu, Cd, Tb, Dy, Ho, Er, Tm, Yb, Lu, Al, Ga and In; each of X, X′ and X″ is independently at least one halogen selected from the group consisting of F, Cl, Br and I; A is at least one rare earth element or metal selected from the group consisting of Y, Ce, Pr, Nd, Sm, Eu, Gd, Th, Dy, Ho, Er, Tm, Yb, Lu, Mg, Cu and Bi; and a, b and z are numbers satisfying the conditions of 0≦a<0.5, 0≦b<0.5 and 0<z<1.0, respectively.

10. The radiation image storage panel of claim 9, wherein M^{I} is Cs, X is Br, A is Eu, and z is a number satisfying the condition of 1×10⁻⁴≦z≦0.1.

11. A process for preparing the radiation image storage panel of claim 1, which comprises the steps of:
preparing a support showing a contact angle of 50° or less with respect to water on one surface thereof, and
depositing a phosphor layer on the surface of the support by gas phase accumulation.
